(19) United States
(12) Patent Application Publication
(10) Pub. No.: US 2025/0301264 A1
(43) Pub. Date: Sep. 25, 2025

(54) SOUND DEVICE

(71) Applicant: AAC Microtech (Changzhou) Co., Ltd., Changzhou (CN)

(72) Inventors: Xin Jin, Changzhou (CN); Weiwei Tao, Changzhou (CN); Fan Zhang, Changzhou (CN)

(21) Appl. No.: 18/741,822

(22) Filed: Jun. 13, 2024

Related U.S. Application Data
(63) Continuation of application No. PCT/CN2024/082580, filed on Mar. 20, 2024.

(51) Int. Cl. H04R 9/06; H04R 7/12; H04R 9/02; H04R 9/04

(52) U.S. Cl. CPC H04R 9/06; H04R 7/127; H04R 9/025; H04R 9/045; H04R 2400/11; H04R 2499/11

(57) ABSTRACT

The present disclosure discloses a sound device including a housing and a speaker unit. The speaker unit of the sound device includes a basket, the vibration system, a magnet system, and an elastic member. The housing of the sound device includes an upper cover, a bottom cover, and a side wall having a sound outlet. A front cavity is formed between the upper cover and the speaker unit. The vibration system includes a diaphragm, a coil and a frame supporting the coil. The magnet system includes a central magnet assembly connected to the upper cover. The frame surrounds the central magnet assembly. A through hole is provided on a side of the frame away from the sound outlet. The sound device in the present disclosure has symmetrical sound quality and smaller amplitude difference.

### FIELD OF THE PRESENT DISCLOSURE

The present disclosure relates to electric-acoustic conversion technologies, especially relates to a sound device.

### DESCRIPTION OF RELATED ART

With the rapid development of mobile communication technologies, consumers have increasingly demand for mobile communication devices with acoustic functions, such as portable phones, handheld game consoles, laptops. Furthermore, as a play device of having acoustic functions, a sound device has significant impact on the improvement of the acoustic performance of the terminal devices.

In related art, a top portion of a magnet assembly is fixed to the housing, thus blocking part of a front cavity of the sound device and resulting in asymmetric sound quality and large amplitude difference between the sound hole side and the non-sound hole side.

Therefore, it is necessary to provide an improved sound device to overcome the problems mentioned above.

### SUMMARY OF THE INVENTION

One object of the present disclosure is to provide a sound device with symmetrical sound quality and smaller amplitude difference.

A sound device including: a housing having a receiving space, including: an upper cover; a bottom cover engaged with the upper cover; and a side wall having a sound outlet; a speaker unit received in the receiving space and enclosed a front cavity with the upper cover, including: a basket; a vibration system mounted on the basket, including: a diaphragm; a coil configured to drive the diaphragm; and a frame configured to support the coil; a magnet system configured to drive the vibration system to generate sound signal, including a central magnet assembly connected with the upper cover; an elastic member configured to support the vibration system; wherein the frame surrounds the central magnet assembly, a through hole is provided on a side of the frame away from the sound outlet.

As an improvement, the frame includes a flat portion connected to the diaphragm, a first connection portion extended from an inner edge of the flat portion and fixed to the coil, a second connection portion extended from an outer edge of the flat portion and fixed to the elastic member, the through hole is provided on the flat portion.

As an improvement, the flat portion includes two long edges opposite to each other, and two short edges connecting the two long edges, the through hole is in a rounded rectangle shape and arranged on the long edge.

As an improvement, the frame includes one through hole symmetrically arranged with a perpendicular bisector of the long edge as the axis of symmetry.

As an improvement, the frame includes a plurality of through holes symmetrically arranged with a perpendicular bisector of the long edge as the axis of symmetry.

As an improvement, the central magnet assembly includes a first main magnet, a second main magnet fixed on the first main magnet, and a third main magnet fixed on the second main magnet; the magnet system further includes a side magnet spaced apart from the central magnet assembly; a magnetic gap is formed between the side magnet and the central magnet assembly; the third main magnet is fixedly connected to the upper cover.

As an improvement, the magnet system further includes a yoke configured to bear the first main magnet, the second main magnet, and the third main magnet; the speaker unit further includes a support portion connected the yoke with the bottom cover.

As an improvement, the diaphragm includes a dome, an outer edge portion connected to one end of the dome, an inner edge portion connected to the other end of the dome; the outer edge portion includes a first fixation portion fixed to the basket; the inner edge portion includes a second fixation portion fixed to the second main magnet.

As an improvement, the speaker unit further includes a circuit board fixed to one end of the elastic member, and an electrical connector fixed to the other end of the elastic member; an external circuit provides power supply for the coil via the circuit board, the elastic member, and the electric connector

### BRIEF DESCRIPTION OF THE DRAWINGS

The accompanying drawings illustrate embodiments and constitute part of the specification, and together with the specification, serve to explain exemplary embodiments of the present disclosure. The accompanying drawings shown are only for illustrative purposes and do not limit the scope of the claims. In all the accompanying drawings, same reference signs refer to similar but not necessarily identical elements.

FIG. 1 is an isometric view of a sound device in accordance with an exemplary embodiment of the present disclosure.

FIG. 2 is an exploded view of the sound device in FIG. 1.

FIG. 3 is an isometric view of a frame of the sound device in FIG. 1.

FIG. 4 is a cross-sectional view of the sound device taken along line A-A in FIG. 1.

FIG. 5 is a cross-sectional view of the sound device taken along line B-B in FIG. 1.

### DETAILED DESCRIPTION OF THE EXEMPLARY EMBODIMENTS

In order to make the inventive objectives, features, and advantages of the present disclosure more understandable, the technical solutions in embodiments of the present disclosure will be described clearly and completely below with reference to the accompanying drawings in the embodiments of the present disclosure. It is apparent that the described embodiments are merely some of rather than all of the embodiments of the present disclosure. All other embodiments acquired by those skilled in the art without creative efforts based on the embodiments in the present disclosure shall fall within the protection scope of the present disclosure.

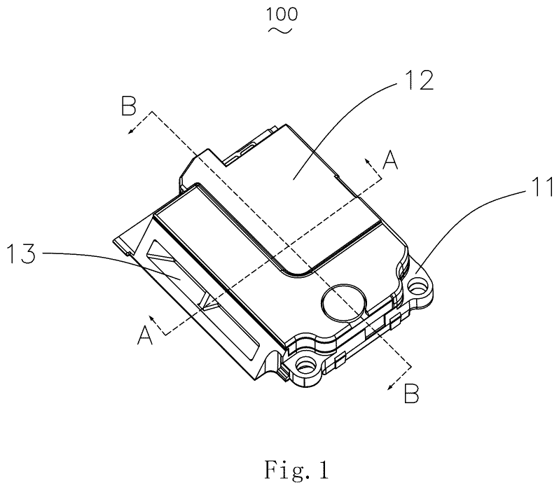

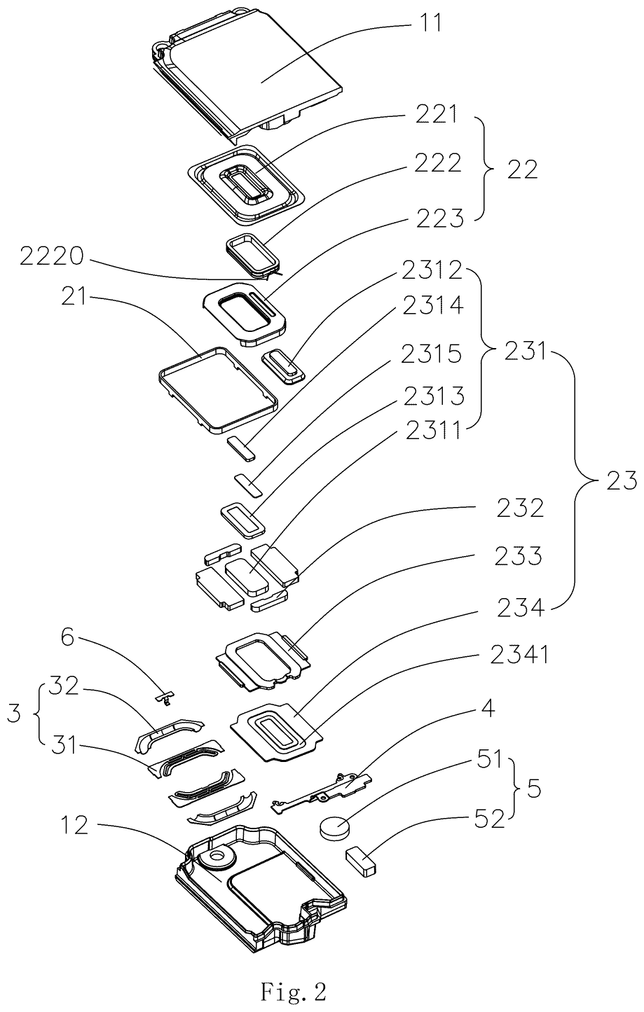

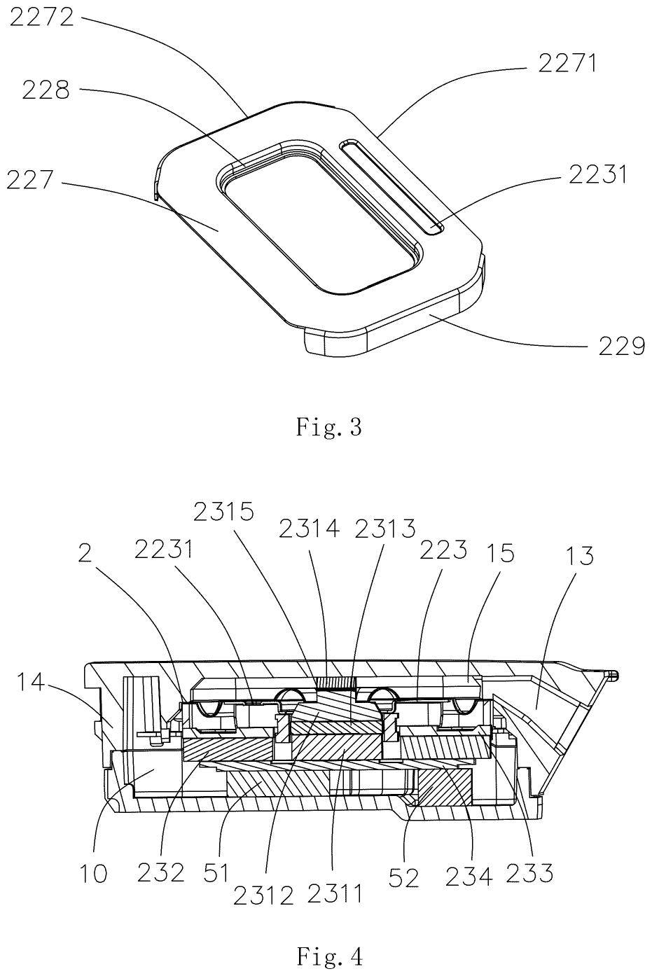

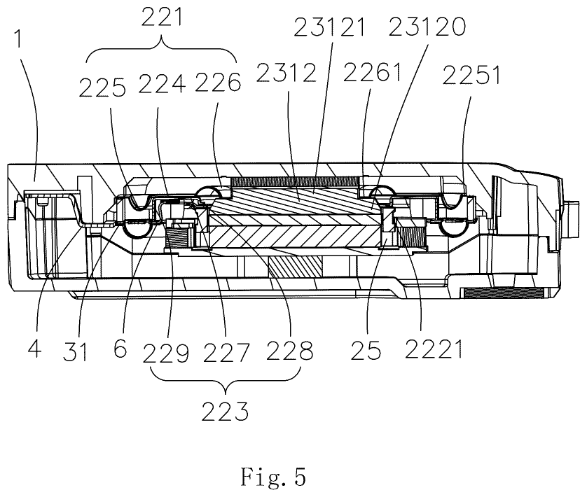

Please refer to FIGS. 1-5, a sound device 100 provided by an exemplary embodiment of the present disclosure includes a housing 1 having a receiving space 10, and a speaker unit 2 received in the receiving space 10.

Specifically, the speaker unit 2 includes a basket 21, a vibration system 22 mounted on the basket 21, a magnet system 23 configured to drive the vibration system 22 to generate sound signal, an elastic member 3 configured to support the vibration system 22, a circuit board 4 fixed to the elastic member 3, a support portion 5 supporting the magnet system 23, and an electrical connector 6. The magnet system 23 includes a central magnet assembly 231 connected to the housing 1.

The housing 1 includes an upper cover 11, a bottom cover 12 engaged with the upper cover 11, and a side wall 14 having a sound outlet 13. A font cavity 15 is enclosed by the speaker unit 2 and the upper cover 11. The side wall 14 is composed by a part bent and extended from an edge of the upper cover 11 and another part bend and extended from an edge of the bottom cover 12. In one embodiment, the upper cover 11, the bottom cover 12, and the side wall 14 are split molded. In another embodiment, the upper cover 11, the bottom cover 12, and the side wall 14 are integrated molded.

Moreover, the vibration system 22 includes a diaphragm 221, a coil 222 configured to drive the diaphragm 221, and a frame 223 configured to support the coil 222. The frame 223 surrounds the central magnet assembly 231.

The diaphragm 221 includes a dome 224 fixed to the frame 223, an outer edge portion 225 connected to one end of the dome 224, and an inner edge portion 226 connected to the other end of the dome 224. The outer edge portion 225 includes a first fixation portion 2251 fixed to the basket 21. The inner edge portion 226 includes a second fixation portion 2261 fixed to the central magnet assembly 231.

The coil 222 includes a lead wire 2220 electrically connected to the electrical connector 6. A recess portion 2221 is provided on a side of the coil 222 to reducing distortion of the speaker unit 2.

The frame 223 includes a flat portion 227 connected to the dome 224, a first connection portion 228 extended from an inner edge of the flat portion 227 and fixed to the coil 222, a second connection portion 229 extended from an outer edge of the flat portion 227 and fixed to the elastic member 3. Besides, a through hole 2231 is provided on a side of the flat portion 227 away from the sound outlet 13.

The flat portion 227 includes two long edges 2271 opposite to each other, and two short edges 2272 connecting the two long edges 2271, the through hole 2231 is in a rounded rectangle shape and arranged on the long edge 2271. Specifically, in one embodiment, the frame 223 includes only one through hole 2231 symmetrically arranged with a perpendicular bisector of the long edge 2271 as the axis of symmetry. In another embodiment, the frame 223 includes a plurality of through holes 2231 symmetrically arranged with a perpendicular bisector of the long side 2271 as the axis of symmetry. It should be noted that the through hole 2231 would be other shapes in other embodiments. By providing the through hole 2231 on the flat portion 227 of the frame 223 that is away from the sound outlet 13, the mass of a part of the frame 227 away from the sound outlet 13 is reduced, thus effectively balancing the asymmetry of sound quality and reducing the maximum amplitude difference between the sound hole side and the non-sound hole side of the speaker unit 2.

Furthermore, the magnet system 23 further includes a side magnet 232 surrounding the central magnet assembly 231, a side yoke 233 located on the side magnet 232, and a yoke 234 configured to bear the central magnet assembly 231 and the side magnet 232. The side magnet 232 is spaced apart from the central magnet assembly 231 to form a magnetic gap 25. The side yoke 233 is fixed to the basket 21. An annular groove 2341 is formed on the yoke 234 for avoiding the coil 222.

The central magnet assembly 231 includes a first main magnet 2311, a second main magnet 2312 fixed on the first main magnet 2311, and a main yoke 2313 sandwiched between the first main magnet 2311 and the second main magnet 2312, a third main magnet 2314 fixed on the second main magnet 2312, and a magnetic plate 2315 sandwiched between the second main magnet 2312 and the third main magnet 2314. Besides, the second main magnet 2312 includes a main portion 23120 and an extension portion 23121 extended from main portion 23120 towards the upper cover 11. The extension portion 23121 is fixed to the magnetic plate 2315. An upper surface of the main portion 23120 is connected to the second fixation portion 2261. The second fixation portion 2261 surrounds the main portion 23120. The third main magnet 2314 is fixedly connected to the upper cover 11.

Additionally, the elastic member 3 includes a metal connector 31, and an auxiliary diaphragm 32 located below the metal connector 31. The elastic member 4 is configured to connect the basket 21 and the frame 223. One end of the metal connector 31 is fixed to the circuit board 4, and the other end of the metal connector 31 is fixed to the electrical connector 6.

The circuit board 4 is partially received in the receiving space 10 and extended outside of the housing 1. An external circuit provides power supply for the coil 222 via the circuit board 4, the metal connector 31 of the elastic member 3, and the electric connector 6.

The support portion 5 is arranged between the speaker unit 2 and the bottom cover 12. Furthermore, the support portion 5 includes a first support part 51 in a shape of cylinder and a second support part 52 in a shape of rectangle. The support portion 5 is made of foam. In this embodiment, the number of the support portion 5 is two. In other embodiments, the speaker unit 2 includes more than two support portions 5 in other shape.

Compared with the related art, the speaker unit of the sound device includes a basket, the vibration system, a magnet system, and an elastic member. The housing of the sound device includes an upper cover, a bottom cover, and a side wall having a sound outlet. A front cavity is formed between the upper cover and the speaker unit. The vibration system includes a diaphragm, a coil and a frame supporting the coil. The magnet system includes a central magnet assembly connected to the upper cover. The frame surrounds the central magnet assembly. A through hole is provided on a side of the frame away from the sound outlet. By providing a through hole on a side of the frame away from the sound outlet, the mass of the part of the frame having the though hole is reduced, thus effectively balancing the asymmetry of sound quality and reducing the maximum amplitude difference between the sound hole side and the non-sound hole side of the speaker unit.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A sound device comprising:
a housing having a receiving space, including:
an upper cover;
a bottom cover engaged with the upper cover; and
a side wall having a sound outlet;
a speaker unit received in the receiving space and enclosed a front cavity with the upper cover, including:
a basket;
a vibration system mounted on the basket, including:
a diaphragm;
a coil configured to drive the diaphragm; and
a frame configured to support the coil;
a magnet system configured to drive the vibration system to generate sound signal, including a central magnet assembly connected with the upper cover;
an elastic member configured to support the vibration system;
wherein the frame surrounds the central magnet assembly, a through hole is provided on a side of the frame away from the sound outlet.

2. The sound device as described in claim 1, wherein the frame comprises a flat portion connected to the diaphragm, a first connection portion extended from an inner edge of the flat portion and fixed to the coil, a second connection portion extended from an outer edge of the flat portion and fixed to the elastic member, the through hole is provided on the flat portion.

3. The sound device as described in claim 2, wherein the flat portion comprises two long edges opposite to each other, and two short edges connecting the two long edges, the through hole is in a rounded rectangle shape and arranged on the long edge.

4. The sound device as described in claim 3, wherein the frame comprises one through hole symmetrically arranged with a perpendicular bisector of the long edge as the axis of symmetry.

5. The sound device as described in claim 3, wherein the frame comprises a plurality of through holes symmetrically arranged with a perpendicular bisector of the long edge as the axis of symmetry.

6. The sound device as described in claim 1, wherein the central magnet assembly comprises a first main magnet, a second main magnet fixed on the first main magnet, and a third main magnet fixed on the second main magnet; the magnet system further comprises a side magnet spaced apart from the central magnet assembly; a magnetic gap is formed between the side magnet and the central magnet assembly; the third main magnet is fixedly connected to the upper cover.

7. The sound device as described in claim 6, wherein the magnet system further comprises a yoke configured to bear the first main magnet, the second main magnet, and the third main magnet; the speaker unit further comprises a support portion connected the yoke with the bottom cover.

8. The sound device as described in claim 6, wherein the diaphragm comprises a dome, an outer edge portion connected to one end of the dome, and an inner edge portion connected to the other end of the dome; the outer edge portion comprises a first fixation portion fixed to the basket; the inner edge portion comprises a second fixation portion fixed to the second main magnet.

9. The sound device as described in claim 1, wherein the speaker unit further comprises a circuit board fixed to one end of the elastic member, and an electrical connector fixed to the other end of the elastic member; an external circuit provides power supply for the coil via the circuit board, the elastic member, and the electric connector.
